(19) United States
(12) Patent Application Publication
(10) Pub. No.: US 2007/0149150 A1
(43) Pub. Date: Jun. 28, 2007

(54) Communication terminal and transmission power control method

(76) Inventor: Yoshio Miyazaki, Kanagawa (JP)

Correspondence Address: KATTEN MUCHIN ROSENMAN LLP, 575 MADISON AVENUE, NEW YORK, NY, 10022-2585, US

(21) Appl. No.: 11/637,609

(22) Filed: Dec. 12, 2006

(30) Foreign Application Priority Data
Dec. 16, 2005 (JP) 2005-362901

(51) Int. Cl. H04B 1/04

(52) U.S. Cl. 455/127.1; 455/450; 455/78; 455/88; 455/90.1; 463/39; 370/310

(57) ABSTRACT

A communication system includes a gaming device, a wireless controller, a handheld gaming device and a personal computer. The gaming device is provided with a first wireless communication module, a second wireless communication module, a controller, an application processor and an output unit, which are accommodated in a housing. The controller manages the gaming device as a whole, the application processor runs a game application, and the output unit outputs the result of running the game application. The second wireless communication module controls the transmission power so as not to affect communication in the first wireless communication module.

### BACKGROUND OF THE INVENTION

1. Field of the Invention

The present invention relates to a communication terminal provided with wireless communication functions and, more particularly, to a communication terminal provided with plural communication modules and to a transmission power control method.

2. Description of the Related Art

Various wireless communication protocols have been proposed and practiced recently. Examples of these protocols include wideband wireless local area network (WLAN) standardized in IEEE802.11 and wireless communication technology (BlueTooth™ protocol) standardized for mobile information devices. These protocols are built in various information terminals for wireless communication with peripheral devices such as personal digital assistants, printers and headsets. Technological innovation in recent years has made it possible to fabricate a wireless communication module with smaller size and reduced cost. It has also become possible to build plural kinds of wireless communication protocols in a single housing.

A wireless communication module is required to transmit a signal to a certain distance and to reproduce a signal by receiving a weak signal transmitted from a peripheral device. For this purpose, a wireless communication module is comprised of a high-output transmitter and a highly sensitive receiver. In the case where wireless communication modules use the same frequency band as in the wireless communication protocol prescribed in IEEE802.11 (hereinafter, referred to as “WLAN protocol”) or in the wireless communication protocol prescribed in IEE802.15.1 (hereinafter, referred to as “BlueTooth protocol”), mutual radio interference between the modules occur, making it difficult to reproduce a signal properly. One approach practiced in the related art to solve the problem like this is to monitor the status of communication using both wireless communication protocols and to control transmission output accordingly.

A first and a second wireless communication modules provided in the same housing are usually placed in close proximity to each other. Given that a first wireless communication module transmits a signal to a third wireless communication module provided in another housing and a second nearby wireless communication module receives from a fourth wireless communication module provided in yet another housing concurrently, the second wireless communication module receives a signal not only from the fourth wireless communication module, but also from the first wireless communication module. In such case, it is difficult for the second communication module to recover the signal transmitted from the fourth wireless communication module, since such recovery is interfered by the signal transmitted from the first wireless communication module.

### SUMMARY OF THE INVENTION

In this background, a general purpose of the present invention is to provide a communication terminal capable of achieving stable communication if plural wireless communication modules are arranged in the same housing.

A transmission power control method according to one embodiment of the present invention is for controlling a transmission power of two wireless communication modules which are provided in the same housing and which communicate using different communication schemes and in the same frequency band. The method comprises: controlling the transmission power of one of the wireless communication modules while the other wireless communication module is receiving. The controlling includes suspending transmission power control if both wireless communication modules are transmitting or if both wireless communication modules are receiving.

The term “same frequency band” refers, for example, to overlapping of frequency bands where at least one of the transmission and reception frequency bands of one module overlaps that of the other. According to the present embodiment, adverse effects on a reception process in one of the wireless communication modules are mitigated by controlling the transmission power of the other module while the reception process is proceeding.

Another embodiment of the present invention relates to a communication terminal The communication terminal comprises: two wireless communication modules which are provided in the same housing and which communicate using different communication schemes and in the same frequency band.

At least one of the two wireless communication modules comprises: an obtaining unit which obtain the status of execution of communication of the other wireless communication module from said other wireless communication module; a transmission power controller which controls the transmission power of said at least one of the wireless communication modules in accordance with the arrangement distance between the two wireless communication modules provided in the housing, if the obtaining unit obtains information indicating that said other wireless communication module is receiving and if said at least one of the two wireless communication modules is transmitting; and a communication unit which performs communication with the transmission power controlled by the transmission power controller.

Optional combinations of the aforementioned constituting elements, and implementations of the invention in the form of methods, apparatuses, systems, recording mediums and programs executable on a computer may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows an example of the structure of a communication system according to an embodiment of the present invention;

FIG. 2 shows an example of the functional blocks of the controller of FIG. 1;

FIG. 3 shows an example of the structure of the first wireless communication module of FIG. 1;

FIG. 4 shows an example of the structure of the second wireless communication module of FIG. 1;

FIG. 5A is a timing chart showing an example of transmission and reception processes performed in the first wireless communication module; FIG. 5B is a timing chart showing an example of transmission and reception processes performed in the second wireless communication module of FIG. 1;

FIG. 6A is a timing chart showing a variation of the process of FIG. 5A; FIG. 6B is a timing chart showing a variation of the process of FIG. 5B;

FIG. 7 is a flowchart showing an example of the operation of the first transmission power controller of FIG. 3; and

FIG. 8 is a flowchart showing an example of the operation of the second transmission power controller of FIG. 4.

### DETAILED DESCRIPTION OF THE INVENTION

The invention will now be described by reference to the preferred embodiments. This does not intend to limit the scope of the present invention, but to exemplify the invention.

The description of a preferred embodiment given with reference to the attached drawings uses specific terms in order to clarify the invention. It should be understood, however, that the invention is not limited in scope to the specific features referred to but encompasses all equivalent technologies implemented according to a similar rule to achieve a similar purpose.

Before giving a specific description of the embodiment, a summary will be given. A communication system according to one particular example of the embodiment of the present invention includes a gaming device and a controller. The gaming device includes two wireless communication modules within a single housing, and the controller supplies an instruction to the gaming device. The two wireless communication modules use the same frequency band. For example, one of the two wireless communication modules communicates via BlueTooth protocol with a controller that gives an instruction to the gaming device or the like. The other module communicates via WLAN protocol with an entity such as a PC or a handheld gaming device, which could be a controller. The two wireless communication modules may use a communication scheme other than BlueTooth protocol or WLAN protocol so long as the scheme allows the modules to use the same frequency band.

Temporal scheduling of execution of communication in the two wireless communication modules is known as one measure to prohibit mutual jamming of communication and prevent communication in one of the modules from disturbing communication in the other. Generally, scheduling requires high processing precision and as such largely affects circuit scale, power consumption, attempts to increase speed and the like. In this respect, the present embodiment is designed to achieve best effort communication in both modules by controlling the transmission power of the wireless communication modules instead of prohibiting jamming by scheduling. Details on this will be given later.

In accordance with the present embodiment, it is possible to permit communication via BlueTooth protocol and communication via WLAN protocol to coexist. By controlling the transmission power appropriately in consideration of the status of execution of communication using one of the communication schemes, both modules can communicate smoothly without suffering from degradation in communication quality. Note that, the term “status of execution of communication” refers, for example, to a mode where communication has yet to take place, a suspended mode and a wait mode as well as encompassing transmission mode, reception mode and the like.

The approach of the embodiment also allows the WLAN-based wireless communication module to control the transmission power autonomously without the intervention of the controller 16. By allowing the WLAN-based wireless communication module communicating via WLAN protocol to control the transmission power autonomously, the controller and the other wireless communication module are relieved of the load. Accordingly, power consumption and/or circuit scale are reduced. The following description assumes that “communication via BlueTooth protocol” is performed by a first wireless communication module and “communication via WLAN protocol” is performed by a second wireless communication module.

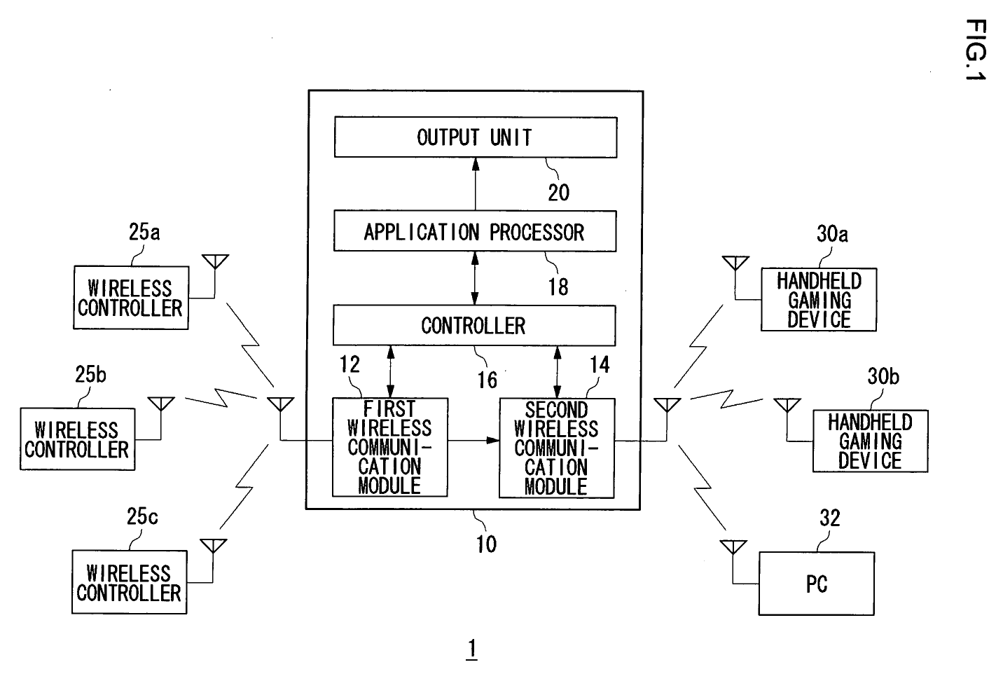

FIG. 1 shows an example of the structure of a communication system 1 according to the present embodiment. The communication system 1 includes a gaming device 10, wireless controllers 25a, 25b and 25c (hereinafter, generically referred to as wireless controllers 25) wirelessly connected with the gaming device 10, handheld gaming devices 30a and 30b (hereinafter, generically referred to as handheld gaming devices 30) and a personal computer 32 (hereinafter, referred to as a PC 32). The gaming device 10 is provided, in a single housing, with a first wireless communication module 12 and a second wireless communication module 14 provided with communication functions, a controller 16 for managing the gaming device as a whole, an application processor 18 for running a game application and an output unit 20 for outputting a result of running the game application. By being provided with the first wireless communication module 12 and the second wireless communication module 14, the gaming device 10 functions as a wireless communication terminal. The first wireless communication module 12 and the second wireless communication module 14 is enabled to communicate using different wireless communication protocols or wireless communication schemes, while using the same frequency band. The first wireless communication module 12 may perform communication by using smaller communication power than the second wireless communication module 14.

In the communication system 1, the wireless controllers 25 are game controllers for controlling the gaming device 10 which allow one or more users to play a game by manipulating the wireless controllers 25 as the users watch a game screen displayed on the display of the gaming device 10. The handheld gaming device 30 is a terminal that allows plural players to play the game at the same time by communicating with another handheld gaming device 30 via the gaming device 10 as a relay station. The handheld gaming device 30 may receive motion picture data from the gaming device 10 so as to deliver a motion picture to the user. The handheld gaming device 30 may also be used as a game controller for controlling the gaming device 10. The user may play a game by manipulating the handheld gaming device 30 as he or she watches a game screen displayed on the display of the gaming device 10. Thus, the gaming device 10 can function to serve plural applications.

The controller 16 functions as an interface for delivery and reception of transmission and reception data between the gaming device 10 and the first wireless communication module 12 or the second wireless communication module 14. The controller 16 facilitates the execution of communication in the modules by notifying the first wireless communication module 12 and the second wireless communication module 14 of parameters necessary for communication in the modules. Details on this will be given later.

In the present embodiment, the first wireless communication module 12 communicates using the BlueTooth protocol and is enabled to connect to the plural wireless controllers 25 wirelessly. In BlueTooth protocol, the frequency-hopping spread spectrum scheme is employed. In the communication system 1, the first wireless communication module 12 functions as a parent device (i.e., a master) for the wireless controllers 25. The wireless controllers 25 function as slaves. A piconet is formed between the first wireless communication module 12 and the wireless controllers 25. A piconet is a network temporarily formed by BlueTooth protocol system terminals as they are brought close to each other. A maximum of 8 BlueTooth terminals can participate in a piconet. Therefore, the first wireless communication module 12, the master, is capable of communicating with a maximum of 7 wireless controllers 25 wirelessly. Basically, the first wireless communication module 12 performs transmission or reception in any time according to a predetermined timing schedule.

The first wireless communication module 12 may communicate with the wireless controllers 25 periodically. In this case, a predetermined transmission period and a predetermined reception period may be set up for communication. The transmission period and the reception period may alternate each other. The duration of the periods may or may not be identical. In each of the periods, the first wireless communication module 12 may not necessarily perform transmission or reception. This may take place when, for example, the number of users participating in a game by using the wireless controllers 25 is small so that the volume of communication is small.

The second wireless communication module 14 performs wireless communication by using the IEEE802.11 protocol and is capable of communicating wirelessly with the plural gaming devices 30 and the PC 32. For example, IEEE802.11b and/or IEEE802.11g may be employed as the IEEE802.11 protocol. In the communication environment using the IEEE802.11 protocol, the second wireless communication module 14 functions as an access point. The MAC layer technology of IEEE802.11 wireless LAN employs Carrier Sense Multiple Access with Collision Avoidance (CSMA/CA) as an access control scheme. An IEEE802.11 terminal is provided with the function of ensuring that a communication channel is idle for a predetermined duration of time before transmitting data. The wait time is a sum of a minimum time and a random time assigned to each terminal. This is to prevent collision of signals from plural terminals transmitting simultaneously after an elapse of certain time since the module communicated previously.

Data related to the processing of the game application is transmitted and received between the first wireless communication module 12 and the wireless controllers 25 and between the second wireless communication module 14 and the handheld gaming devices 30. Therefore, real-timeness in information transmission is basically, if not uniformly, required. The phrase “real-timeness is required” encompasses a requirement whereby retransmission is either not assumed or permitted and/or a requirement whereby permitted processing delay is small. For example, real-timeness is a quality whereby the user's manipulation of the wireless controller 25 or the handheld gaming device 30 is entirely and properly transmitted to the gaming device 10 without letting the user feel uncomfortable and whereby the process associated with the manipulation is properly executed in the gaming device 10 and the execution is reflected on screen display.

It will be noted that since the first wireless communication module 12 and the second wireless communication module 14 use the same frequency band, jamming may occur if both communicate at the same time. This is addressed in the present embodiment by causing the second wireless communication module 14, which implements the WLAN protocol used for communication between the second wireless communication module 14 and the handheld gaming devices 30, to control its transmission power in consideration of the status of communication between the first wireless communication module 12 and the wireless controllers 25. In turn, the first wireless communication module 12, which implements the BlueTooth protocol used for communication between the first wireless communication module 12 and the wireless controllers 25, is caused to control its transmission power in consideration of the status of communication between the second wireless communication module 14 and the handheld gaming device 30.

In other words, each of the first wireless communication module 12 and the second wireless communication module 14 controls its own transmission power to a level that does not affect communication in the other wireless communication module. Such a structure facilitates providing a communication environment and/or a game execution environment comfortable to the user. Even if plural users use plural applications at the same time, it would not interrupt communication and/or game play. Each of the first wireless communication module 12 and the second wireless communication module 14 may operate autonomously so that communication in the other wireless communication module is not interrupted, in accordance with a parameter-based instruction sent from the controller 16 and/or information related to the communication status sent from the other wireless communication module. The above-mentioned scheduling may be totally managed by the controller 16 and achieved by sending an appropriate instruction to the first wireless communication module 12 and the second wireless communication module 14.

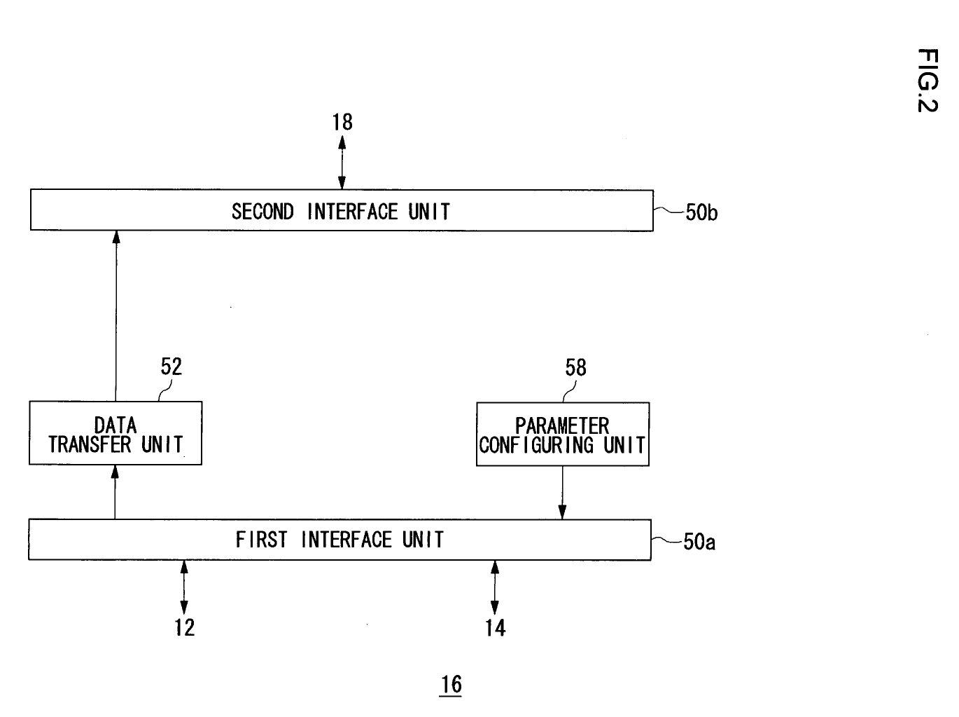

FIG. 2 shows an example of the functional blocks of the controller 16 of FIG. 1. The controller 16 is provided with a first interface unit 50a and a second interface unit 50b for data transmission and reception to and from other parts of the structure. The first interface unit 50a interfaces with the first wireless communication module 12 and the second wireless communication module 14, and the second interface unit 50b interfaces with the application processor 18. The first interface unit 50a and the second interface unit 50b may be an integral structure that shares the hardware. The communication management function of the controller 16 in the gaming device 10 is implemented by a CPU, a memory, a program loaded into the memory and the like. FIG. 2 depicts functional blocks implemented by the cooperation of the elements. The program may be built in the gaming device 10 or supplied from an external source in the form of a recording medium. Therefore, it will be obvious to those skilled in the art that the functional blocks may be implemented by a variety of manners including hardware only, software only or a combination of both.

The controller 16 further includes a data transfer unit 52 and a parameter configuration unit 58. The controller 16 is provided with the function of controlling and managing the gaming device 10 as a whole. FIG. 2 particularly depicts functional blocks for managing communication in the gaming device 10.

The data transfer unit 52 transmits a manipulation input acknowledged in the first interface unit 50a to the application processor 18 via the second interface unit 50b. The application processor 18 performs a process in accordance with the manipulation input so that the game proceeds. Game applications are largely categorized into two groups in respect of requirement for real-time processing, i.e., into a group of games with relatively severe requirement for real-time processing and a group of games with less severe requirement for real-time processing. A game with severe requirement for real-time processing is characterized by a rapid game development and a need for immediate reflection of a user input in an output such as a game screen etc. Beat'-em-up games or racing games would be given as examples. A game with less severe requirement for real-time processing is characterized by a comparatively slow game development. Match-up games like Japanese chess and mah-jong as well as role playing games (RPG) would be given as examples.

The parameter configuration unit 58 configures parameters for each of the first wireless communication module 12 and the second wireless communication module 14. The parameters configured include at least “arrangement distance”. The term “arrangement distance” refers, for example, to a distance between the first wireless communication module 12 and the second wireless communication module 14 arranged in the gaming device 10. For example, the term may refer to a distance between the antenna end of a module and that of the other. The “arrangement distance” is used when each of the first wireless communication module and the second wireless communication module 14 controls its transmission power.

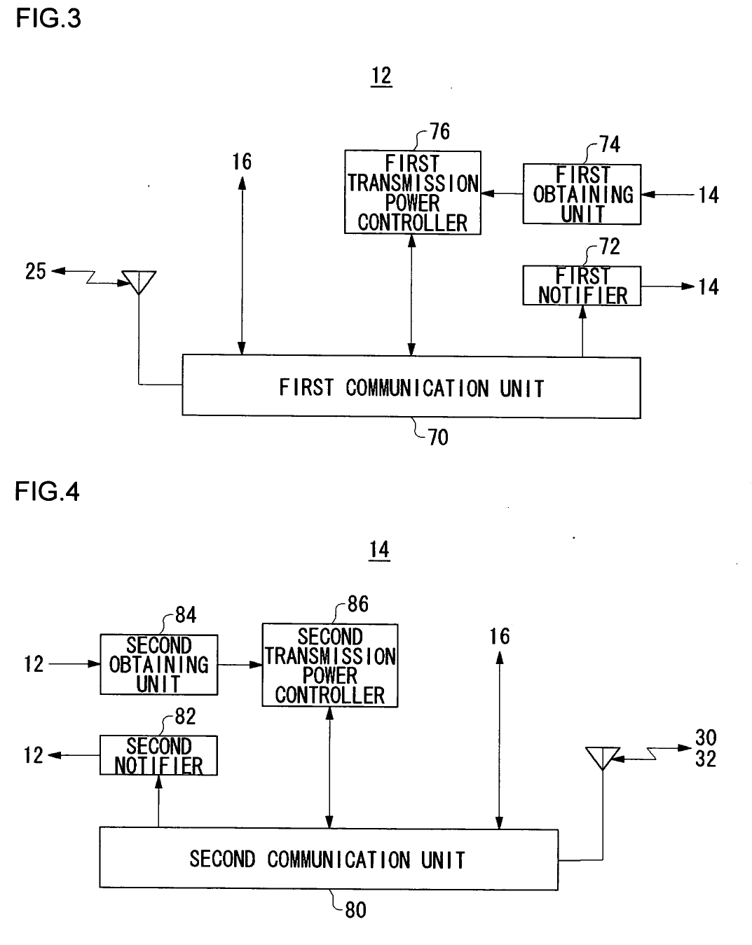

FIG. 3 shows an example of the structure of the first wireless communication module 12 of FIG. 1. The first wireless communication module 12 includes a first communication unit 70, a first notifier 72, a first obtaining unit 74 and a first transmission power controller 76. The first communication unit 70 receives a manipulation input related to a game application from one or plural wireless controllers 25. The first communication unit 70 supplies the number of controllers participating in communication or a game, or also supplies the manipulation input, to the application processor 18 via the controller 16 of FIG. 1. The application processor 18 of FIG. 1 runs the game application in accordance with the received manipulation input. The output unit 20 of FIG. 1 comprises a display, a speaker and the like. The result of process performed by the application processor 18 is output via the output unit 20.

The first communication unit 70 transmits information indicating the status of execution of communication to the first notifier 72. The first notifier 72 transmits the information indicating the status of execution of communication transmitted from the first communication unit 70 to the second wireless communication module 14. Communication of the information is done via the wiring within the gaming device 10 of FIG. 1 or, alternatively, by wireless means. The information indicating the status of execution of communication may be transmitted as state pulses. State pulses are pulse signals indicating a transmission mode when high and a reception mode when low. When the first wireless communication module 12 neither transmits nor receives, the state pulse is a signal of 0 amplitude. The state pulse may be defined as a signal indicating a time interval in which the first wireless communication module 12 is permitted to transmit or receive. In this case, the state pulse is at a high level or a low level irrespective of whether the module actually transmits or receives. The state of execution of communication may be transmitted to the second wireless communication module 14 via the controller 16.

The first obtaining unit 74 obtains information indicating the status of execution of communication transmitted from the second wireless communication module 14. The first obtaining unit 74 also transmits the information indicating the status of execution of communication in the second wireless communication module 14 to the first transmission power controller 76. The status of communication in the second wireless communication module 14 may be obtained by monitoring the status of communication via the antenna in the second wireless communication module 14. In this case, the first obtaining unit 74 obtains information indicating that the reception antenna in the second wireless communication module 14 is being operated. If the antenna in the second wireless communication module 14 is used for both transmission and reception, the first obtaining unit 74 may only have to obtain a signal indicating which of the modes the antenna is being operated in. Alternatively, the first obtaining unit 74 may obtain a signal with which the second wireless communication module 14 indicates the mode in which the antenna should be operated. Alternatively still, the first obtaining unit 74 may obtain the information indicating the status of communication via the controller 16. The first obtaining unit 74 periodically obtains the status of communication in the second wireless communication module 14 at least while the first wireless communication module 12 is performing a transmission process.

The first transmission power controller 76 controls the transmission power by considering the information indicating the status of execution of communication in the second wireless communication module 14 transmitted from the first obtaining unit 74 and the information indicating the status of execution of communication in the first wireless communication module 12 transmitted from the first communication unit 70. The first transmission controller 76 may control the transmission power if the first wireless communication module 12 is in the transmission mode and the second wireless communication module 14 is in the reception mode. More specifically, the first transmission power controller 76 controls the transmission power if the second wireless communication module 14 is in the reception mode when the first wireless communication module 12 starts a transmission process. The first transmission power controller 76 may reduce the transmission power if the second wireless communication module 14 makes a transition from the transmission mode or the suspended mode to the reception mode in a period in which the first wireless communication module 12 already started and is still performing a transmission process.

The first transmission power controller 76 may continue to control the transmission power so as to return the reduced transmission power to the original level, if the second wireless communication module 14 makes a transition from the reception mode to the transmission mode or to the communication suspended mode in a period in which the first transmission power controller 76 already reduced the transmission power and the first wireless communication module 12 is continuing its transmission process. By continuing transmission power control in such a situation, sophisticated control is achieved. Alternatively, the first transmission power controller 76 may suspend transmission power control and continue communication with the reduced transmission power. By suspending transmission power control in a case like this, the process is simplified. Naturally, both approaches do not affect communication in the other wireless communication module.

Specifically, transmission power control is performed as described below. The first transmission power controller 76 subtracts a control power value, which is derived in accordance with the arrangement distance L transmitted from the controller 16, from the transmission power PO configured for the first communication unit 70. The control power value is derived such that the smaller the arrangement distance, the more significant the reduction in transmission power. In addition to the arrangement distance, the control power value may be configured in consideration of free space propagation loss Loss in a space between the first wireless communication module 12 and the second wireless communication module 14. To summarize the above, the transmission power P1 as controlled is given by the expression (1) below.
P1=P0−Loss−P2(L) (1)
where P2(L) denotes a function the value of which is determined by the arrangement distance L. The smaller the value of L, the larger the value returned by the function.

FIG. 4 shows an example of the structure of the second wireless communication module 14 of FIG. 1. The second wireless communication module 14 includes a second communication unit 80, a second notifier 82, a second obtaining unit 84 and a second transmission power controller 86. The second communication unit 80 receives status information from one or plural handheld gaming devices 30. The second communication unit 80 also transfers information from the controller 16 to the handheld gaming devices 30 participating in the WLAN. This allows a game application to be run in the gaming device 10 such that the status information in the handheld gaming devices 30 is reflected so that the plural users can play the game simultaneously using the respective handheld gaming devices 30. In case the handheld gaming device 30 is used as a game controller, the second communication unit 80 supplies a manipulation input from the handheld gaming device 30 to the application processor 18 via the controller 16. In case the handheld gaming device 30 is used as a terminal for receiving motion picture, the second communication unit 80 delivers motion picture data to the handheld gaming device 30. The second communication unit 80 also transmits and receives data such as motion picture to and from the PC 32. The second communication unit 80 transmits information indicating the status of execution of communication to the second transmission controller 86. The information indicating the status of execution of communication is information indicating the transmission mode, the reception mode or the suspended mode.

The second wireless communication module 14 determines when to control the transmission power for transmission to an entity with which it communicates (the handheld gaming device 30 or the PC 32), by using the information transmitted from the first notifier 72 of the first wireless communication module 12 and indicating the status of execution of communication. In accordance with the present embodiment, the process of the first wireless communication module 12 and that of the second wireless communication module 14 can be synchronized. By allowing the second wireless communication module 14 to know a control timing of the transmission power, mutual radio interference between wireless communication modules is autonomously reduced or eliminated, thereby enabling stable communication in the gaming device 10.

The second communication unit 80 transmits information indicating the status of execution of communication to the second notifier 82. The second notifier 82 transmits to the first wireless communication module 12 the information indicating the status of execution of communication transmitted from the second communication unit 80. Communication of the information is done via the wiring within the gaming device 10 of FIG. 1 or, alternatively, by wireless means. The status of communication in the second wireless communication module 14 may be obtained by allowing the second communication unit 80 to monitor the status of communication via the antenna in the second wireless communication module 14. In this case, the second notifier 82 outputs information indicating that the reception antenna in the second wireless communication module 14 is being operated. If the antenna in the second wireless communication module 14 is used both for transmission and reception, the second notifier 82 may output a signal indicating which of the modes the antenna is being operated in. Alternatively, the second notifier 82 may output a signal indicating a specific antenna to be used. This signal may be indicated from the second wireless communication module 14 to the antenna. Alternatively still, the second notifier 82 may transmit the information indicating the status of execution of communication to the first wireless communication module 12 via the controller 16.

The second obtaining unit 84 obtains information indicating the status of execution of communication transmitted from the first wireless communication module 12. The second obtaining unit 84 also transmits the information indicating the status of execution of communication in the first wireless communication module 12 thus obtained to the second transmission power controller 86. The second transmission power controller 86 controls the transmission power by considering the information indicating the status of execution of communication in the first wireless communication module 12 transmitted from the second obtaining unit 84 and the information indicating the status of execution of communication in the second wireless communication module 14 transmitted from the second communication unit 80. The second obtaining unit 84 periodically obtains the status of communication in the first wireless communication module 12 at least while the second wireless communication module 14 is performing a transmission process.

The second transmission power controller 86 may control the transmission power if the first wireless communication module 12 is in the transmission mode and if the second wireless communication module 14 is in the reception mode. As in the first transmission power controller 76 described above, control of the transmission power may be in accordance with the expression (1). The initial transmission power configured for the second communication unit 80 may be larger than the initial transmission power P0 configured in the first transmission power controller 76 of FIG. 3.

In one alternative, the second transmission power controller 86 may control the transmission power if the first wireless communication module 12 is in the reception mode when the second wireless communication module 14 starts a transmission process. The second transmission power controller 86 may reduce the transmission power if the first wireless communication module 12 makes a transition from the transmission mode or the suspended mode to the reception mode in a period in which the second wireless communication module 14 already started and is still performing a transmission process.

The second transmission power controller 86 may continue to control the transmission power so as to return the reduced transmission power to the original level, if the first wireless communication module 12 makes a transition from the reception mode to the transmission mode or to the communication suspended mode in a period in which the second transmission power controller 86 already reduced the transmission power and the second wireless communication module 14 is continuing its transmission process. By continuing transmission power control in such a situation, sophisticated control is achieved. Alternatively, the second transmission power controller 86 may suspend transmission power control and continue communication with the reduced transmission power. By suspending transmission power control in a case like this, the process is simplified. Naturally, both approaches do not affect communication in the other wireless communication module.

The second transmission controller 86 may control the transmission power of the second wireless communication module 14 not only when the first wireless communication module 12 is in the reception mode but also when it is in the transmission mode. Generally, the BlueTooth protocol executed in the first wireless communication module 12 requires smaller transmission power than the WLAN protocol executed in the second wireless communication module 14. The above-mentioned control could be due because transmission by the first wireless communication module 12 is affected by transmission by the second wireless communication module 14 if both wireless communication modules are concurrently in the transmission mode.

If the second wireless communication module 14 is configured to transmit information indicating acknowledgement of reception (hereinafter, referred to as an ACK signal) to the handheld gaming device 30 or the PC 32 in response to a signal transmitted from the handheld gaming device 30 or the PC 32 to the second wireless communication module 14, the second transmission power controller 86 may not control the transmission power of the ACK signal even if the first wireless communication module 12 is in the reception mode. This is because the ACK signal is of short duration and is unlikely to affect communication in the first wireless communication module 12. If the ACK signal is not transmitted properly to the handheld gaming device 30 or the like, the handheld gaming device 30 or the like will continue to retransmit the same data signal to the second wireless communication module 14 until the ACK signal is properly transmitted. Therefore, the transmission power of the ACK signal may not be controlled in order to ensure that the ACK signal is properly transmitted to the handheld gaming device 30 or the like. If the ACK signal is likely to be transmitted properly to the handheld gaming device 30 or the like even if the transmission power thereof is reduced due to its low transmission rate, the second transmission power controller 86 may control the transmission power of the ACK signal. By employing the present embodiment, stable communication environment in the gaming device 1 is achieved.

The structure described above may be implemented hardwarewise by LSIs such as a CPU and a memory of an arbitrary computer and softwarewise by, for example, a program loaded into the memory executable on a computer with control functions. The figures depict functional blocks implemented by cooperation of the hardware and software. Therefore, it will be obvious to those skilled in the art that the functional blocks may be implemented by a variety of manners including hardware only, software only or a combination of both.

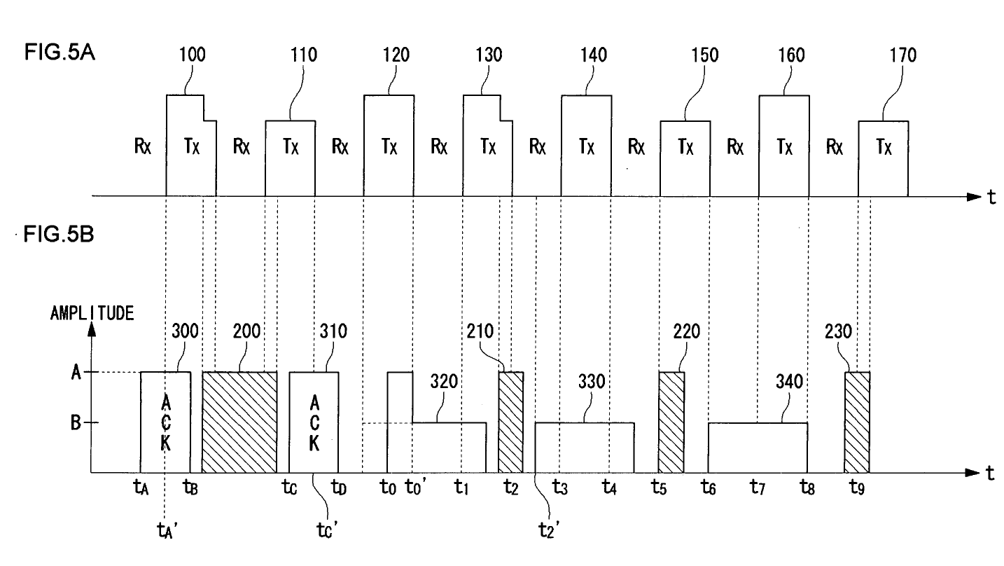

A detailed description will now be given with reference to FIGS. 5A and 5B of transmission power control by the first wireless communication module 12 and the second wireless communication module 14 according to the present embodiment. FIG. 5A is a timing chart showing an example of transmission and reception processes performed in the first wireless communication module 12 of FIG. 1. FIG. 5B is a timing chart showing an example of transmission and reception processed performed in the second wireless communication module 14 of FIG. 1. In the timing charts of FIGS. 5A and 5B, the horizontal axis represents a time axis t. The vertical axis represents amplitude. FIG. 5A shows that transmission Tx and reception Rx alternate in the first wireless communication module 12. Transmission signals including transmission signal 100—transmission signal 170 are shown. FIG. 5A also shows how the transmission power is controlled in respective transmission time intervals, as indicated by transmission signal 100, transmission signal 110, transmission signal 130, transmission signal 150 and transmission signal 170. FIG. 5B shows transmission signals from the second wireless communication module 14 including transmission signal 300—transmission signal 340. FIG. 5B also shows reception signals reception signal 200—reception signal 230 of the second wireless communication module 14. FIGS. 5A and 5B show that a transmission process is performed in respective transmission periods as the transmission power is controlled in consideration of the status of communication in the other wireless communication module. The term “information indicating the status of execution of communication” mentioned before may encompass information indicating transmission power as well as information indicating the transmission mode or the reception mode, as shown in FIGS. 5A and 5B.

As shown in FIG. 5A, the first wireless communication module 12 communicates with the wireless controllers 25. As shown in FIG. 5B, the second wireless communication module 14 receives reception signal 200—reception signal 230 at times independent of the status of execution of communication in the first wireless communication module 12. Accordingly, the transmission power of the first wireless communication module 12 is reduced in time intervals in which reception signal 200—reception signal 230 are received and in which the first wireless communication module 12 is performing a transmission process. In the other time intervals, the transmission power of the first wireless communication module 12 is not reduced. More specifically, in time intervals in which transmission signal 100, transmission signal 110, transmission signal 130, transmission signal 150 and transmission signal 170 are transmitted, the second wireless communication module 14 concurrently receives reception signal 200—reception signal 230, respectively. Therefore, each transmission power of the transmission signals of the first wireless communication module 12 is reduced once the reception of these reception signals by the second wireless communication module 14 is started. The transmission power of the first wireless communication module 12 for transmitting transmission signal 110, transmission signal 150 and transmission signal 170 is maintained at a reduced level even if the second wireless communication module 14 makes a transition from the reception mode to the transmission mode or the suspended mode in the middle of the time intervals in which these transmission signals are transmitted.

As shown in FIG. 5B, in a time interval between t0 and t8, the second wireless communication module 14 transmits a data signal to the handheld gaming device 30 or the like with transmission power A or transmission power B. As shown in FIG. 5A, the first wireless communication module 12 is in the reception mode in time intervals between t0′ and t1, between t2 and t3, between t4 and t5 and between t6 and 67. Therefore, in these time intervals, the transmission power of the second wireless communication module 14 is reduced from power A to power B. In the other time intervals, the transmission power is not reduced below power A. In other words, the second transmission power controller 86 suspends transmission power control in time intervals other than those mentioned above. The transmission power of the second wireless communication module 14 for transmitting transmission signal 330 and transmission signal 340 is maintained at a reduced level even if the first wireless communication module 12 makes a transition from the reception mode to the transmission mode at times t1, t3 and t7, respectively.

As shown in FIG. 5B, the second wireless communication module 14 sends an ACK signal to the handheld gaming device 30 in time intervals between tA and tB and between tC and tD. The first wireless communication module 12 is in the reception mode in time intervals between tA and tA′ and time intervals between tC′ and tD. However, the ACK signal continues to be transmitted with the transmission power A in these intervals because the transmission power should not be controlled even if the first wireless communication module 12 is in the reception mode.

While the description with reference to FIG. 5B was given on an assumption that the transmission power is available in two levels A and B, the transmission power may assume other values. In other words, the control power value for controlling the transmission power A may be variable. For example, the control power value may be configured such that the transmission power is reduced to B′, which is larger than B, in the case of an ACK signal and to B in the case of a data signal.

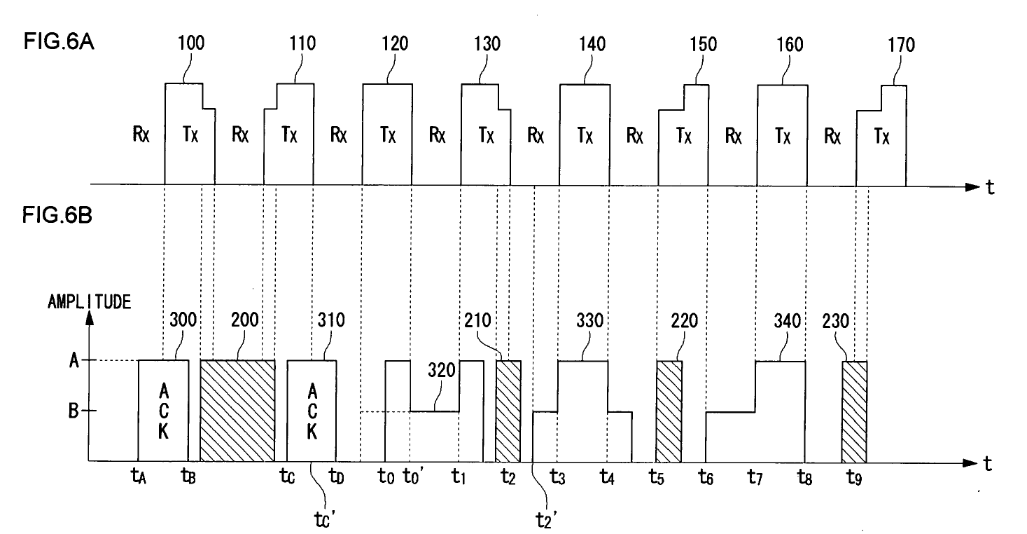

A detailed description will now be given, with reference to FIGS. 6A and 6B, of a variation of transmission power control according to the embodiment performed in the first wireless communication module 12 and the second wireless communication module 14. FIG. 6A is a timing chart showing a variation of the process of FIG. 5A. FIG. 6B is a timing chart showing a variation of the process of FIG. 5B. Referring to FIGS. 6A and 6B, the second transmission power controller 86 may return the reduced transmission power to the original level, if the first wireless communication module 12 makes a transition from the reception mode to the transmission mode or to the communication suspended mode in a period in which the second transmission power controller 86 already reduced the transmission power and the second wireless communication module 14 is continuing its transmission process. For example, unlike the process of FIG. 5B wherein communication proceeds with the reduced transmission power when the first wireless communication module 12 makes a transition from the reception mode to the transmission mode at times t1, t3 and t7, the second transmission power controller 86 returns the reduced transmission power to its original level. In FIGS. 5A and 5B and FIGS. 6A and 6B, like numerals represent like elements and the description with reference to FIGS. 6A and 6B will be simplified.

More specifically, in time intervals in which transmission signal 100, transmission signal 110, transmission signal 130, transmission signal 150 and transmission signal 170 are transmitted, the second wireless communication module 14 concurrently receives reception signal 200—reception signal 230, respectively. Therefore, the transmission power of the first wireless communication module 12 is reduced once the reception of these signals by the second wireless communication module 14 is started. It will be noted that the second wireless communication module 14 makes a transition from the reception mode to the transmission mode or to the suspended mode in the middle of each of the time intervals in which transmission signal 110, transmission signal 150 and transmission signal 170 are transmitted. In association with this transition, the first wireless communication module 12 returns its transmission power to its original level, and then, continues its transmission process.

Further, as indicated by transmission signal 330 of FIG. 6B, in association with the transition of the first wireless communication module 12 from the reception mode to the transmission mode at t3, the second wireless communication module 14 returns its transmission power to its original level before continuing its transmission process. In association with the transition of the first wireless communication module 12 from the transmission mode to the reception mode at t4, the second wireless communication module 14 reduces its transmission power again before continuing its transmission process.

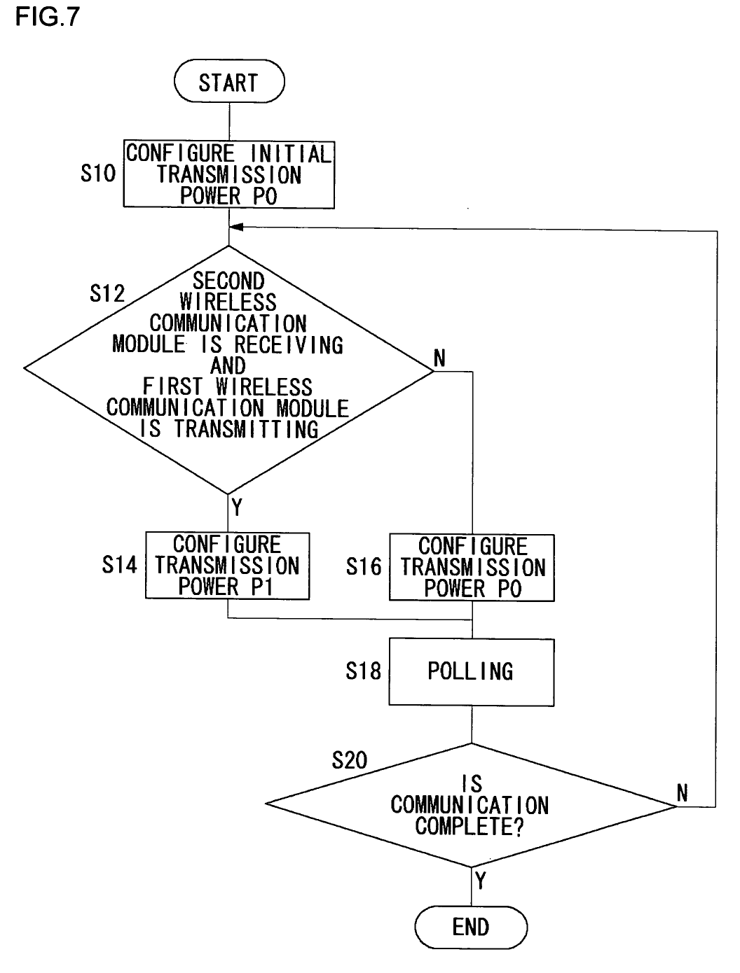

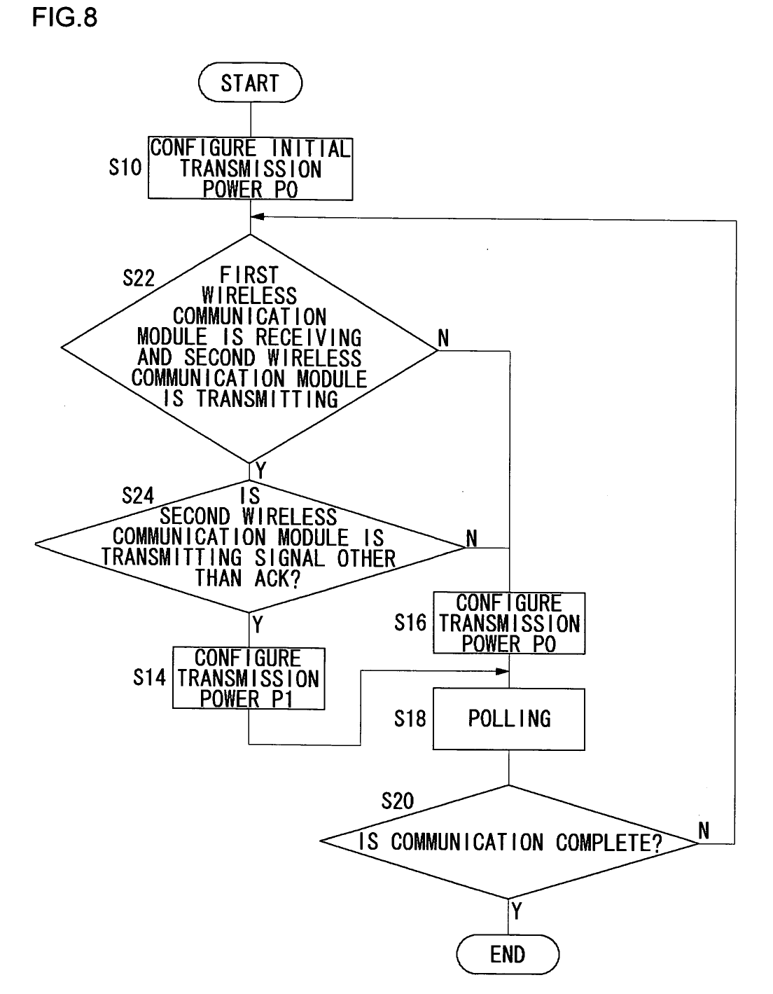

A description will now be given, with reference to FIGS. 7 and 8, of the flow of operation, illustrated in FIGS. 6A and 6B, of the first transmission power controller 76 of the first wireless communication module 12 and the second transmission power controller 86 of the second wireless communication module 14. FIG. 7 is a flowchart showing an example of the operation of the first transmission power controller 76 of FIG. 3. FIG. 8 is a flowchart showing an example of the operation of the second transmission power controller 86 of FIG. 4. In FIGS. 7 and 8, like numerals represent like elements and the description with reference to FIG. 7 will be simplified.

Firstly, the operation will be described with reference to FIG. 7. The first transmission power controller 76 configures the initial transmission power P0 for the first communication unit 70 (S10). Secondly, the first transmission power controller 76 configures the transmission power P1 for the first communication unit 70 if it is determined, by referring to the information transmitted from the first obtaining unit 74 and the first communication unit 70, that the first wireless communication module 12 is transmitting and the second wireless communication module 14 is receiving (Y in S12). The transmission power P1 thus configured is derived according to the expression (1) and is of a value smaller than that of the initially configured transmission power P0. In contrast, if it is determined that the first wireless communication module 12 is receiving or the second wireless communication module 14 is transmitting (N in S12), the first transmission controller 76 configures a transmission power larger than the transmission power P1 configured in S14. The transmission power configured in this process may be identical with the initial transmission power P0. Subsequently, the first transmission power controller 76 executes a polling process (idle loop or standby) (S18). The duration of polling operation may be determined depending on how sophisticated transmission control should be. The duration may be predefined or dynamically varied. The first transmission power controller 76 then determines whether communication is completed in the first communication unit 70. If it is determined that communication is completed (Y in S20), the operation is terminated. If it is not determined that communication is completed (N in S20), the first transmission power controller 76 repeats S12 and subsequent steps. By performing the process described above, the first wireless communication module 12 provided with the first transmission power controller 76 is capable of the operation as shown in FIG. 6A.

The description with reference to FIG. 8 will now be given. The difference from the operation of FIG. 7 is that steps S22 and S24 are provided. In S22, the second transmission power controller 86 proceeds to S24 if it is determined, by referring to the information transmitted from the second obtaining unit 84 and the second communication unit 80, that the first wireless communication module 12 is receiving and the second wireless communication module 14 is transmitting (Y in S22). If such a determination is not made (N in S22), the second transmission power controller 86 proceeds to S16 and subsequent steps. In S24, the second transmission power controller 86 determines whether an ACK signal is being transmitted, by referring to the information transmitted from the second communication unit 80. If it is determined that a signal other than the ACK signal is in transmission (Y in S24), the second transmission power controller 86 proceeds to S14. If it is not determined that a signal other than the ACK signal is in transmission (N in S24), control proceeds to S16. Determination in S22 and S24 may be integrated. By performing the process described above, the second wireless communication module 14 provided with the second transmission power controller 86 is capable of the operation as shown in FIG. 6B.

According to the embodiment, best effort communication in both wireless communication modules is achieved by controlling the transmission power of the modules. The WLAN-based second wireless communication module 14 is capable of controlling the transmission power autonomously without the intervention of the controller 16. By allowing the WLAN-based wireless communication module 14 communicating via WLAN to control its transmission power autonomously, the controller 16 and the first wireless communication module 12 are relieved of the load. Accordingly, power consumption and/or circuit scale are reduced. Adverse effects on a reception process in one of the wireless communication modules are mitigated by controlling the transmission power of the other module while the reception process is proceeding. By suspending the control of the transmission power while the two wireless communication modules are performing the same process, smooth communication is maintained. By allowing one of the wireless communication modules to directly obtain information indicating the status of execution of communication in the other wireless communication module, efficient control is achieved. By controlling the transmission power in accordance with the arrangement distance between the wireless communication modules, proper transmission power control is achieved. The second wireless communication module 14 is capable of knowing a duration in which the transmission power for transmitting to the handheld gaming device 30 or the PC 32 should be controlled, by referring to a signal transmitted from the first wireless communication module 12 and indicating the status of communication. In accordance with this approach, the process in the first wireless communication module 12 and that of the second wireless communication module 14 can be synchronized. By allowing the second wireless communication module 14 to know when to control the transmission power, mutual radio interference between wireless communication modules is autonomously reduced or eliminated, thereby enabling stable communication in the gaming device 10.

The description of the invention given above is based upon the embodiment. The embodiment is illustrative in nature and those skilled in the art would readily appreciate that various variations in constituting elements and processes involved are possible and such variations are also within the scope of the present invention.

What is claimed is:

1. A transmission power control method for controlling a transmission power of two wireless communication modules which are provided in the same housing and which communicate using different communication schemes and in the same frequency band, the method comprising:
controlling the transmission power of one of the wireless communication modules while the other wireless communication module is receiving, wherein
the controlling includes suspending transmission power control if both wireless communication modules are transmitting or if both wireless communication modules are receiving.

2. The transmission power control method according to claim 1, wherein the controlling includes suspending transmission power control in said other wireless communication module if said other wireless communication module communicates to respond to a signal from an entity it communicates with, by transmitting information indicating acknowledgement of reception to said entity.

3. The transmission power control method according to claim 1, wherein the controlling includes controlling the transmission power in accordance with the arrangement distance between the two wireless communication modules provided in the housing.

4. The transmission power control method according to claim 1, wherein the controlling includes reducing the transmission power such that the smaller the arrangement distance between the two wireless communication modules, the more significant the reduction in the transmission power.

5. The transmission power control method according to claim 1, further comprising:
allowing one of the wireless communication modules which is communicating to obtain the status of execution of communication of the other wireless communication module, wherein
the controlling includes controlling the transmission power in accordance with the status of execution of communication obtained in the obtaining.

6. The transmission power control method according to claim 5, wherein
the controlling includes controlling the transmission power of said one of the wireless communication modules transmitting, by subtracting a control power value, which is defined in accordance with the arrangement distance between the two wireless communication modules provided in the housing, from the transmission power of said one of the wireless communication modules transmitting, if one of the two wireless communication modules is transmitting and if the allowing obtains information indicating that the other wireless communication module is receiving.

7. The transmission power control method according to claim 1, wherein the controlling includes configuring the transmission power of one of the two wireless communication modules to be larger than that of the other wireless communication module.

8. The transmission power control method according to claim 7, wherein
the controlling includes reducing the transmission power of the other wireless communication module, while one of the wireless communication modules for which the transmission power is configured to be lower is transmitting or receiving.

9. The transmission power control method according to claim 1, wherein
the controlling includes suspending transmission power control, if said other wireless communication modules makes a transition from a reception mode to a transmission mode or to a communication suspended mode in a period in which the controlling has started transmission power control and said one of the wireless communication modules is continuing its transmission process.

10. The transmission control method according to claim 1, wherein
the controlling includes continuing transmission power control, if said other wireless communication modules makes a transition from a reception mode to a transmission mode or to a communication suspended mode in a period in which the controlling has started transmission power control and said one of the wireless communication modules is continuing its transmission process.

11. A communication terminal comprising:
two wireless communication modules which are provided in the same housing and which communicate using different communication schemes and in the same frequency band, wherein
at least one of the two wireless communication modules comprises:
an obtaining unit which obtain the status of execution of communication of the other wireless communication module from said other wireless communication module;
a transmission power controller which controls the transmission power of said at least one of the wireless communication modules in accordance with the arrangement distance between the two wireless communication modules provided in the housing, if the obtaining unit obtains information indicating that said other wireless communication module is receiving and if said at least one of the two wireless communication modules is transmitting; and
a communication unit which performs communication with the transmission power controlled by the transmission power controller.

12. The communication terminal according to claim 11, wherein the transmission power controller
reduces the transmission power such that the smaller the arrangement distance, the more significant the reduction in the transmission power.
